(19) United States
(12) Patent Application Publication
(10) Pub. No.: US 2017/0144294 A1
(43) Pub. Date: May 25, 2017

(54) ERGONOMIC AND VERSATILE PAD-CARRYING TOOL

(71) Applicants: William Eugene Manovich, Friendswood, TX (US); Michael Richard Smith, Friendswood, TX (US)

(72) Inventors: William Eugene Manovich, Friendswood, TX (US); Michael Richard Smith, Friendswood, TX (US)

(21) Appl. No.: 15/161,334

(22) Filed: May 23, 2016

Related U.S. Application Data
(60) Provisional application No. 62/258,635, filed on Nov. 23, 2015.

(51) Int. Cl. B25G 3/38; B08B 1/00; A46B 5/00; A47L 13/16; A47L 13/28; A47L 9/32; B25G 1/04; B25G 1/10

(52) U.S. Cl. CPC B25G 3/38; B25G 1/04; B08B 1/002; B08B 1/006; B25G 1/102; A47L 13/16; A47L 13/28; A47L 9/322; A46B 5/0054

(57) ABSTRACT

A hand tool provides a user with an ergonomic structure that allows simple and effective contact with even opposed surfaces. The hand tool is an extended element having multiple components. The tool further has:
a tool head;
a connection system connected to the tool head;
a pole secured at its distal end to the connection system;
a pole having on its proximal end a hand grip area.

The pole includes a stem unit having a bend within the stem unit between 8 and 30 degrees from linear along the pole.

### RELATED APPLICATION DATA

This Application claims priority from U.S. Provisional Patent Application Ser. No. 62/258,635 field 23 Nov. 2015.

### BACKGROUND OF THE INVENTION

1. Field of the Invention

The present invention relates to the field of hand tools, particularly hand tools on pole extenders, particularly hand tools carrying functional pads on a distal end of the pole extender.

2. Background of the Art

Hand tools are the earliest evidence of mechanical extension of the human body. Even some primates other than humans have been found to use simple straws or sticks as crude tools or implements. Some of the earlier tools using poles as extensions of tools are the spear (an extension of the knife) and the broom (an extension of a duster or brush).

The earliest extensions were for centuries merely straight poles with basic tools attached. Very little changes occurred in the poles, usually attached by tension from wrappings applied over the pole and the basic tool. Later attachments came from pegs, and ultimately male-female couplings, with initially tension gripping between the two elements or an internal thread (on the female coupling) and external thread (on the male element) that may be screwed together and unscrewed for replacement of the pole or the tool.

Among examples of tools with extensions for use in applying liquids, applying pressure, applying abrasive action and the like are provided in U.S. Pat. Nos. 4,300,258; 6,305,046; 6,953,299; and 8,650,699; and US Patent Publications 200100046407 and 20040146332. Additional commercial tools are like the Vikan® angle brush, which has a brush head, a stem on the head, an angled connector attached to the head, and a pole that is connected to the angled connector.

Novel and ergonomic extension poles and tools are still useful in the commercial and domestic world.

### SUMMARY OF THE INVENTION

A hand tool provides a user with an ergonomic structure that allows simple and effective contact with even opposed surfaces. The hand tool is an extended element having multiple components. The tool further has:
a tool head;
a connection system connected to the tool head;
a pole secured at its distal end to the connection system;
a pole having on its proximal end a hand grip area.

The pole includes a stem unit having a bend within the stem unit between 8 and 30 degrees from linear along the pole.

### BRIEF DESCRIPTION OF THE FIGURES

FIG. 1 is a side view of a hand tool according to the present invention.

FIG. 2 is a side view of a hand tool according to the present invention with a wider bend than in FIG. 1.

FIG. 2A is a top segment view of the end of one embodiment of the tool of the present invention.

FIG. 3 is a back view of a hand tool according to the present invention.

FIG. 4 is a back view of a hand tool according to the present invention without an extending post in the connector.

FIG. 5 is a side view of a hand tool according to the present invention without an extending post in the connector.

FIG. 6 is a front view of a hand tool according to the present invention without an extending post in the connector.

FIG. 7 is a back view of a hand tool according to the present invention with an extending post in the connector.

### DETAILED DESCRIPTION OF THE INVENTION

A hand tool provides a user with an ergonomic structure that allows simple and effective contact with even opposed surfaces. The hand tool may be used for cleaning, scrubbing, painting, application of liquids, removal of material off of surfaces, removal of dust, contemporaneous application and removal of materials and the like. The hand tool is an extended or extension element having multiple components. By extended is meant that the tool is an extension from the hand to provide a distal effect by manipulation of the tool by the user's hand(s).

The tool further has 1) a tool head; 2) a connection system connected to the tool head; 3) a pole secured at its distal end to the connection system; 4) the pole having on its proximal end a hand grip area.

The pole includes a stem unit having a bend within the stem unit between 8 and 30 degrees from linear along the pole.

The 1) tool head has an application surface used in its designed function. This may be a pad, a sheet, a brush, an applicator, abrasive element, pressure applicator, vacuum and the like. A source of material (e.g., liquid or gas supply) may be associated with the tool head.

The 2) connection system is a connector such as a snap engagement, male female connection, externally threaded male post and internally threaded opening, male post with expanding and retracting pin, or any other adjustable locking and unlocking system so that the tool head can be exchanged or replaced. The connection system may be part of the tool head or a separate intermediate element.

The 3) pole may be compositionally any materials typically used for tool handles, including but not limited to wood, metal, polymers, reinforced polymers, composites, alloys, blends of materials, and the like. The pole may be solid, rigid, flexible, a single piece, multiple engaging pieces, or even telescoping with a position locking component.

The 4) hand grip may be a simple pole end, or may be ergonomically shaped, contoured and composited. It could be rubber, elastic, foamed, hand receptor shape, grooved to receive one or more specific digits, and the like.

The hand tool may provide the pole as a single solid elongate element with the bend at a location more than 50% of a length of the pole away from the proximal end and more than 10%, more than 15% and even more than 20% of the length of the pole away from the distal end of the pole. The hand tool may have the pole as two combined solid elongate elements with the bend at a location more than 50% of a length of the pole away from the proximal end of the two combined solid elongate elements and more than 10% of the length of the pole away from the distal end of the pole. The position of the angular variation on the pole may be alternatively expressed as a bend occurring between 50% and 85% or 90% of a distance along a length between the hand grip area towards the connection system. The bend may be relatively sharp, stepped (multiple bends), curvilinear, maintaining the relatively linearity of the pole, or providing a skewed angle.

The hand tool of claim 1 wherein the connection system provides a fixed angle between the tool head and the pole, or wherein the connection system provides a pivoting angle between the tool head and the pole.

Reference to the Figures will assist in a further understanding of the present invention.

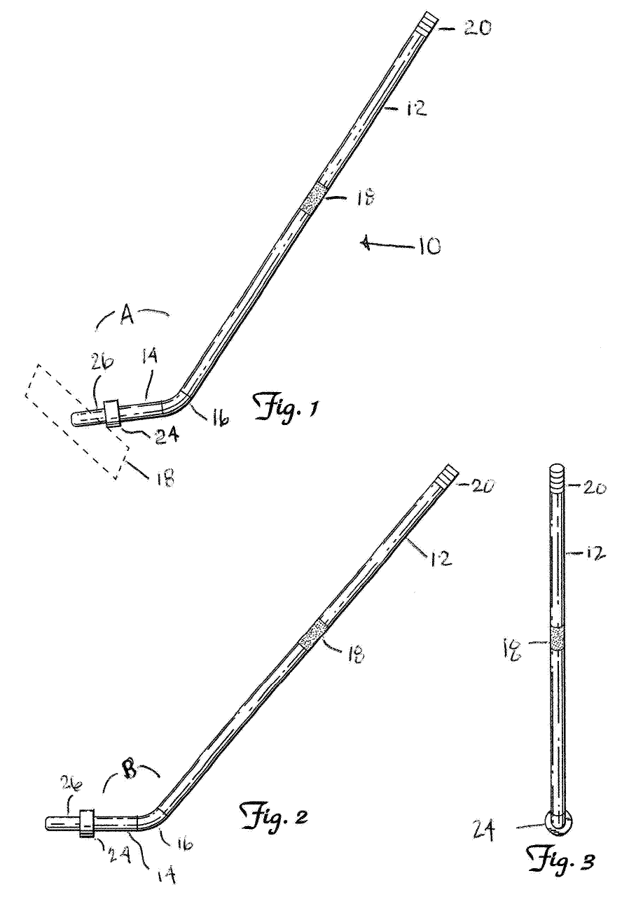

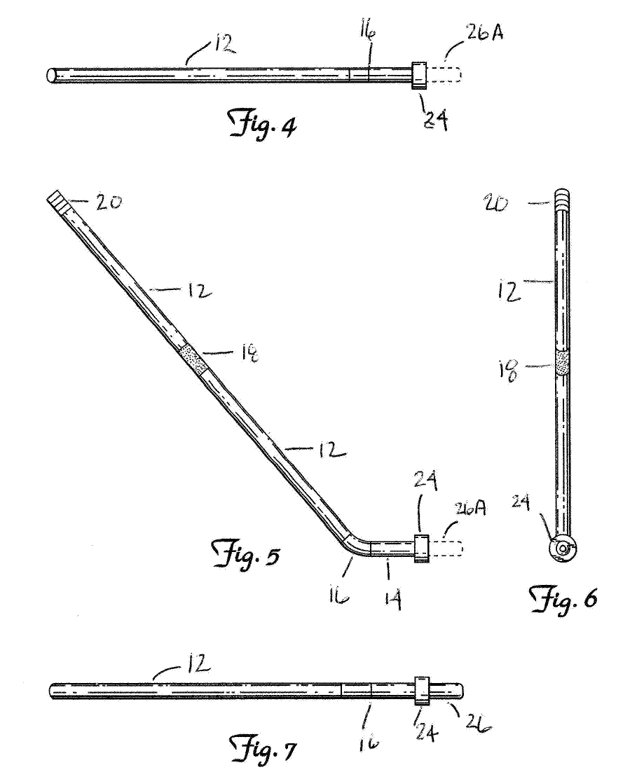

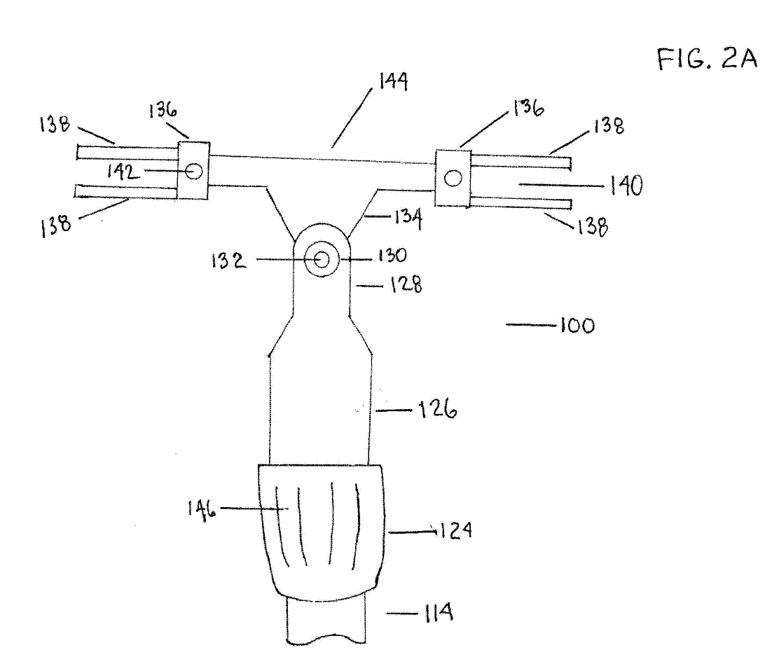

FIG. 1 is a side view of a hand tool shaft lOaccording to the present invention. The shaft 10 is shown with an extended proximal portion 12 and an angled distal portion 14 connected by a curved segment 16 of the generally continuous shaft 12. The curve creates an angle of between 8 and 60 degrees between an axis of the proximal portion 12 and an axis of the distal portion 14 immediately between the section 22 of the proximal portion 12 and the distal portion 14. The shaft 10 is shown with a mid-shaft gripping surface 18 and a proximal handle surface 20. The two elements 18 and 20 may be coatings or sleeves placed on the shaft 10 or they may be molded or cut into the surface of the shaft 10. At the tip 26 of the distal portion of the shaft 14 is shown aa generic pad attachment 28 and a connection/locking element 24 (shown in greater detail in FIG. 2).

The curved segment 16 (with an interior angle A therein) shown in FIG. 1 has a rather harsh curvature (sharp angle) to it. More gentle curves or sharper curves may also be used. The preferred angle is between 30 and 60 degrees, or between 30 and 45 degrees.

FIG. 2 is a side view of a hand tool according to the present invention with a slightly wider bend than in FIG. 1 (with an interior angle B therein which is greater than A in FIG. 1)

FIG. 2A is a top segment view of the end 100 of one embodiment of the tool of the present invention. The end 200 is shown with the truncated distal portion of the shaft 114, a locking attachment element 124, an engagement neck 126 to a pad/brush/abrading element (not shown) which is attached to the arm pairs 138 extending from the pad-supporting elements 136. There is a center bar 144 that supports the pad-supporting elements 136, and the pad-supporting elements 136 may be rotated, swiveled, or telescoped to adjust for different sizes of pads (not shown). The arms 138 are shown forming a space 140 into which additional connection may be made to the pads or other functional elements secured to the arms 136. Rather than pairs of arms, a single arm (as a sleeve support) or more than two arms may be present. The arms may pivot through space 140 and locking by a locking or tightening element 142 to pinch or grasp a pad. The center bar 144 may also pivot, pronate, rotate or shift orientation through connecting elements 130 and 132 on the forward extension 128 of the locking neck 126. A broadening neck 134 between the connecting elements 130 and 132 to the center bar 144 is also shown. Gripping pattern 146 is shown on the locking attachment element 124 which can be a hand-screwed connector, a snap-on connector, and the like. Any form of connector may be used.

In all figures, identical numbers are identical elements or components.

FIG. 3 is a back view of a hand tool according to the present invention.

FIG. 4 is a back view of a hand tool according to the present invention without an extending post in the connector.

FIG. 5 is a side view of a hand tool according to the present invention without an extending post in the connector.

FIG. 6 is a front view of a hand tool according to the present invention without an extending post in the connector.

FIG. 7 is a back view of a hand tool according to the present invention with an extending post in the connector.

These and other features of the present technology described herein may be modified by the designer, and remain within the scope of the generic claims. The device may readily be used to apply functionality (scrubbing, scraping, liquid application and the like) to opposed surfaces of bath tubs and show stalls without significant alteration of user positions. By rotating the shaft 180 degrees, with the user standing in a same position, the angle of contact of the pads/brushes, etc. are reversed and the functional face of the pads can be used alternatively against the opposed surfaces. When brush a tub, for example, having the pads face the user is will enable scrubbing of the nearer interior surface of the tub, and then reversing the shaft (180 degrees) will allow contact with the opposed distal interior surface of the tub. Similarly with opposed vertical surfaces of a shower stall, the user may remain in a single position and reverse (rotate) the shaft 180 degrees, and scrub alternative ones of the opposed surfaces.

That process would be performed by a method of cleaning opposed surfaces a tub or shower with a hand tool with an extending element having:
a tool head;
a connection system connected to the tool head;
a pole secured at its distal end to the connection system; and
a pole having on its proximal end a hand grip area; wherein the pole comprises a pole unit having a bend within the pole unit between 8 and 60 degrees from linear, the process comprising a user in a first location relative to the tub or shower positioning the tool head against a first opposed surface of the tub or shower, and then rotating the extending element and the tool head 180 degrees to face a second one of the opposed surface of the tub or shower, without the user moving from the first location.

What is claimed:

1. A hand tool with an extending element comprising:
a tool head;
a connection system connected to the tool head;
a pole secured at its distal end to the connection system;
a pole having on its proximal end a hand grip area;
wherein the pole comprises a pole unit having a bend within the pole unit between 8 and 60 degrees from linear.

2. The hand tool of claim 1 wherein the pole unit is a single solid elongate element with the bend at a location more than 50% of a length of the pole away from the proximal end.

3. The hand tool of claim 1 wherein the pole unit comprises two combined solid elongate elements with the bend at a location more than 50% of a length of the pole away from the proximal end of the two combined solid elongate elements.

4. The hand tool of claim 1 wherein the bend occurs between 50% and 85% of a distance along a length between the hand grip area towards the connection system.

5. The hand tool of claim 2 wherein the bend occurs between 50% and 85% of a distance along a length between the hand grip area towards the connection system.

6. The hand tool of claim 3 wherein the bend occurs between 50% and 85% of a distance along a length between the hand grip area towards the connection system.

7. The hand tool of claim 1 wherein the connection system provides a fixed angle between the tool head and the pole.

8. The hand tool of claim 1 wherein the connection system provides a pivoting angle between the tool head and the pole.

9. A method of cleaning opposed surfaces a tub or shower with a hand tool with an extending element comprising:
a tool head;
a connection system connected to the tool head;
a pole secured at its distal end to the connection system; and
a pole having on its proximal end a hand grip area;
wherein the pole comprises a pole unit having a bend within the pole unit between 8 and 60 degrees from linear, the process comprising a user in a first location relative to the tub or shower positioning the tool head against a first opposed surface of the tub or shower, and then rotating the extending element and the tool head 180 degrees to face a second one of the opposed surface of the tub or shower, without the user moving from the first location.

10.
